(19) United States
(12) Patent Application Publication
(10) Pub. No.: US 2026/0280650 A1
(43) Pub. Date: Sep. 17, 2026

(54) STANDALONE SIDELINK CHANNEL STATE INFORMATION REFERENCE SIGNAL

(71) Applicant: Apple Inc., Cupertino, CA (US)

(72) Inventors: Chunxuan Ye, San Diego, CA (US); Dawei Zhang, Saratoga, CA (US); Haitong Sun, Saratoga, CA (US); Hong He, San Jose, CA (US); Jie Cui, San Jose, CA (US); Wei Zeng, Saratoga, CA (US)

(21) Appl. No.: 19/473,029

(22) PCT Filed: Apr. 2, 2024
(86) PCT No.: PCT/US2024/022648

§ 371 Date: Oct. 6, 2025

Related U.S. Application Data
(60) Provisional application No. 63/457,957, filed on Apr. 7, 2023.

(51) Int. Cl. H04B 7/06; H04W 72/25

(52) U.S. Cl. CPC H04B 7/0626; H04B 7/06952; H04W 72/25

(57) ABSTRACT

Methods or systems are configured for receiving, by a user equipment (UE), a sidelink channel state reference signal (CSI-RS) transmission on a first resource pool dedicated for CSI-RS transmissions; transmitting, by the UE and based on the CSI-RS transmission, a beam report to a paired UE, the beam report being based on a transmission beam and a receiver beam associated with a source identifier and a destination identifier in sidelink control information (SCI); and receiving, based on the transmission beam and the receiver beam of the beam report, a transmission on a second resource pool for data transmissions.

### CLAIM OF PRIORITY

This application claims priority under to U.S. Patent Application Ser. No. 63/457,957, filed on Apr. 7, 2023, the entire contents of which are hereby incorporated by reference.

### BACKGROUND

Wireless communication networks provide integrated communication platforms and telecommunication services to wireless user devices. Example telecommunication services include telephony, data (e.g., voice, audio, and/or video data), messaging, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

### SUMMARY

This document describes methods and systems for standalone sidelink (SL) Channel State Information Reference Signal (CSI-RS) transmission. A user equipment (UE) can transmit a CSI-RS for several different SL operations in the frequency range 2 (FR2) licensed spectrum. For example, a UE can use a CSI-RS transmission for sidelink beam management, including initial beam-pairing, beam maintenance, and beam failure recovery, among other SL operations. The UE can reuse the existing SL CSI framework and Uu beam management concepts in some scenarios. However, beam management in the FR2 licensed spectrum considers sidelink unicast communication only. This disclosure describes how a UE achieves fast beam sweeping for beam measurement. This disclosure describes a physical layer structure for a slot with multiple SL CSI-RSs. This disclosure describes a set of different procedures for transmitting the SL CSI-RS.

The disclosure enables one or more of the follow advantages. Generally, the transmitting UE (Tx UE) that transmits the CSI-RS may need to transmit the CSI-RS in more than one direction. If the CSI-RS is transmitted together with the data channel, as occurs with CSI-RS on the physical SL shared channel (PSSCH), beam training requires that some data be transmitted by the Tx UE. This would introduce inefficiencies, because the Tx UE would need to wait to transmit data to transmit the CSI-RS.

To overcome this technical problem, a standalone CSI-RS transmission is described that uses fast beam sweeping. A standalone CSI-RS transmission can be transmitted without SL data transmission. Because the CSI-RS may need to be transmitted in different directions, in one slot the Tx UE may transmit the CSI-RS in different directions using beam sweeping. However, this may cause automatic gain control (AGC) issues at the receiver (Rx). This is because transmission of multiple CSI-RSs using beam sweeping can cause a signal strength of the CSI-RS to vary during a slot. In SL operations, the first symbol in the slot is dedicated for AGC to enable the receiver to control the signal strength for the slot with a given level. Switching beams during the slot can cause the AGC to be ineffective at the receiver.

The fast beam sweeping by the Tx UE includes placement of an AGC symbol prior to each SL CSI-RS transmission of the Tx UE. This enables the Rx UE to adjust its AGC for each transmitted standalone SL CSI-RS. In a legacy frame structure, each slot's first symbol is dedicated to use of AGC adjustment. The standalone SL CSI-RS updates the slot to include an AGC symbol for each SL CSI-RS transmission. For fast beam sweeping, the result is that a slot can have multiple AGC symbols. The slot that includes the multiple AGC symbols is dedicated for CSI-RS transmission.

In SL transmissions, each slot has AGC symbol for enabling Rx UE gain adjustment, because multiple distributed UEs can be transmitting and can contribute to signal strength, as a UE can communicate with any other UE. In Uu links, AGC symbol does not need to be included at the beginning of each slot. Rather, for a Uu link, the AGC is considered separately from the CSI-RS slot, because the UE is receiving the transmission from a base station.

This document also describes the resource allocation for the slots for dedicated CSI-RS transmissions. The resource allocation can specify particular slots as being dedicated for standalone SL CSI-RS transmissions, without data being included in the slot. The UE can therefore transmit the SL CSI-RS without requiring data for beam training or for sending the CSI-RS on a data channel. In some implementations, the resource allocation includes a dedicated resource pool for sidelink CSI-RS transmission. In some implementations, the resource allocation includes dependent transmissions on a dedicated resource pool for SL CSI-RS transmissions and a resource pool for data transmission. In some implementations, the sidelink control information (SCI) on a legacy resource pool for data transmission is configured to reserve the resources for sidelink CSI-RS transmission. In some implementations, a shared resource pool is used for sidelink CSI-RS transmission. In some implementations, a resource pool based sidelink CSI-RS configuration is performed.

In an aspect, a method includes receiving, by a user equipment (UE), a sidelink channel state reference signal (CSI-RS) transmission on a first resource pool dedicated for CSI-RS transmissions; transmitting, by the UE and based on the CSI-RS transmission, a beam report to a paired UE, the beam report being based on a transmission beam and a receiver beam associated with a source identifier and a destination identifier in sidelink control information (SCI); and receiving, based on the transmission beam and the receiver beam of the beam report, a transmission on a second resource pool for data transmissions.

In some implementations, the transmission on the second resource pool includes a physical sidelink control channel (PSCCH) or physical sidelink shared channel (PSSCH)

In some implementations, the process includes receiving, from the paired UE, a SCI transmission specifying a resource of the first resource pool that is selected by the paired UE for transmission of the CSI-RS, wherein the CSI-RS is received by the UE using the selected resource of the first resource pool.

In some implementations, the SCI is transmitted using a slot of the second resource pool.

In some implementations, the SCI specifies the resource of the first resource pool for transmission of the CSI-RS using a container in SCI stage 1.

In some implementations, the SCI specifies the resource of the first resource pool for transmission of the CSI-RS using a container in SCI stage 2.

In some implementations, the SCI specifies a time slot of the first resource pool for the CSI-RS transmission.

In some implementations, the SCI specifies a sub-channel index the first resource pool for the CSI-RS transmission.

In some implementations, the SCI specifies a periodicity for the CSI-RS transmission using the first resource pool.

In some implementations, the SCI specifies an index of the first resource pool.

In some implementations, the first resource pool is reserved for CSI-RS transmissions only.

In some implementations, the first resource pool is reserved for CSI-RS transmissions and SCI stage 2 transmissions. In some implementations, the SCI stage 2 transmissions include a full source identifier identifying the paired UE and/or a full destination identifier identifying the UE. In some implementations, the SCI stage 2 transmissions include a partial source identifier the paired UE and/or a partial destination identifier identifying the UE.

In some implementations, the first resource pool is reserved for CSI-RS transmissions and SCI stage 1 transmissions. In some implementations, the first resource pool includes one or more slots that are dedicated for CSI-RS transmissions, the one or more slots being configured or preconfigured by the first resource pool. In some implementations, a bitmap indicates the one or more slots, the bitmap including values specifying each slot that is dedicated for SL CSI-RS transmissions and each slot that is used for data transmissions. In some implementations, a bitmap indicates the one or more slots, the bitmap including values specifying each slot that is dedicated for SL CSI-RS transmissions.

In some implementations, each slot in the first resource pool that is dedicated for CSI-RS transmissions includes a symbol for automatic gain control (AGC) for each CSI-RS transmission associated with the slot. In some implementations, a slot in the first resource pool that is dedicated for CSI-RS transmissions includes an additional AGC symbols for each beam configured for transmission of a respective CSI-RS in the slot. In some implementations, the slot is configured for transmission of the CSI-RS on at least two beams.

In some implementations, the first resource pool and the second resource pool are part of a shared resource pool on a single frame structure.

In some implementations, the process includes performing beam pairing using a CSI-RS configured or preconfigured by resource pool. In some implementations, the CSI-RS is transmitted using a wide beam.

A non-transitory computer storage medium encoded with instructions that, when executed by one or more computers, cause the one or more computers to perform the methods described herein.

A system comprising one or more processors and one or more storage devices on which are stored instructions that are operable, when executed by the one or more processors, to cause the one or more processors to perform the methods described herein.

An apparatus comprising one or more baseband processors configured to perform the methods described herein.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates an example communication system that includes sidelink communications, according to some implementations.

FIG. 2A illustrates an example of a frame structure for dedicated SL CSI-RS transmission.

FIG. 2B illustrates an example of a frame structure for dedicated SL CSI-RS transmission.

FIG. 3A illustrates an example physical layer slot for a standalone SL CSI-RS transmission.

FIG. 3B illustrates an example physical layer slot for a standalone SL CSI-RS transmission.

FIG. 3C illustrates an example physical layer slot for a standalone SL CSI-RS transmission.

FIG. 4A illustrates an example of resource allocation for a standalone SL CSI-RS transmission.

FIG. 4B illustrates an example of resource allocation for a standalone SL CSI-RS transmission.

FIG. 4C illustrates an example of resource allocation for a standalone SL CSI-RS transmission.

FIGS. 5A-5B illustrate example processes for resource allocation for a standalone SL CSI-RS transmission in accordance with the resource allocation of FIG. 4A.

FIGS. 6A-6B illustrate example processes for resource allocation for a standalone SL CSI-RS transmission in accordance with the resource allocation of FIG. 4B.

FIGS. 7A-7B illustrate example processes for resource allocation for a standalone SL CSI-RS transmission in accordance with the resource allocation of FIG. 4C.

FIG. 8 illustrates an example user equipment (UE), according to some implementations.

FIG. 9 illustrates an example access node, according to some implementations.

### DETAILED DESCRIPTION

Sidelink operations on FR2 is an objective in the sidelink domain for new radio (NR) telecommunications networks. This document describes methods and systems for standalone sidelink (SL) Channel State Information Reference Signal (CSI-RS) transmission, in which the SL CSI-RS is transmitted without data on the data channel, such as a physical sidelink shared channel (PSSCH). The transmitting (Tx) UE allocates a slot for a standalone CSI-RS transmission. The slot is specifically for SL CSI-RS transmission and does not include data. The Tx UE uses fast beam sweeping to transmit multiple CSI-RSs in different directions. To avoid causing automatic gain control (AGC) issues at the receiver(s) (Rx) as different beams are used, each CSI-RS transmission is preceded by an AGC symbol in the slot. The AGC symbol enables the receiver to adjust the gain control until another AGC symbol is provided. The slot therefore can include multiple AGC symbols.

This document also describes the resource allocation by a Tx UE for the slots for dedicated CSI-RS transmissions. The resource allocation can specify particular slots as being dedicated for standalone SL CSI-RS transmissions, without data being included in the slot. The UE can therefore transmit the SL CSI-RS without requiring data for beam training or for sending the CSI-RS on a data channel.

This document describes a frame structure for the slot for transmission of the SL CSI-RS. These are dedicated slots for SL CSI-RS transmissions, as previously described. This document describes a slot structure for the SL CSI-RS slot. This document describes resource allocation for sidelink CSI-RS transmissions. In some implementations, the resource allocation includes a dedicated resource pool for sidelink CSI-RS transmission. In some implementations, the resource allocation includes dependent transmissions on a dedicated resource pool for SL CSI-RS transmissions and a resource pool for data transmission. In some implementations, the sidelink control information (SCI) on a legacy resource pool for data transmission is configured to reserve the resources for sidelink CSI-RS transmission. In some implementations, a shared resource pool is used for sidelink CSI-RS transmission. Dedicated slots are provided for sidelink CSI-RS transmissions, and other slots are provided for PSCCH/PSSCH transmissions. In another example, a resource pool based sidelink CSI-RS configuration is performed. The configuration can be used for initial beam pairing, and the sidelink CSI-RS beams can be wide beam transmissions.

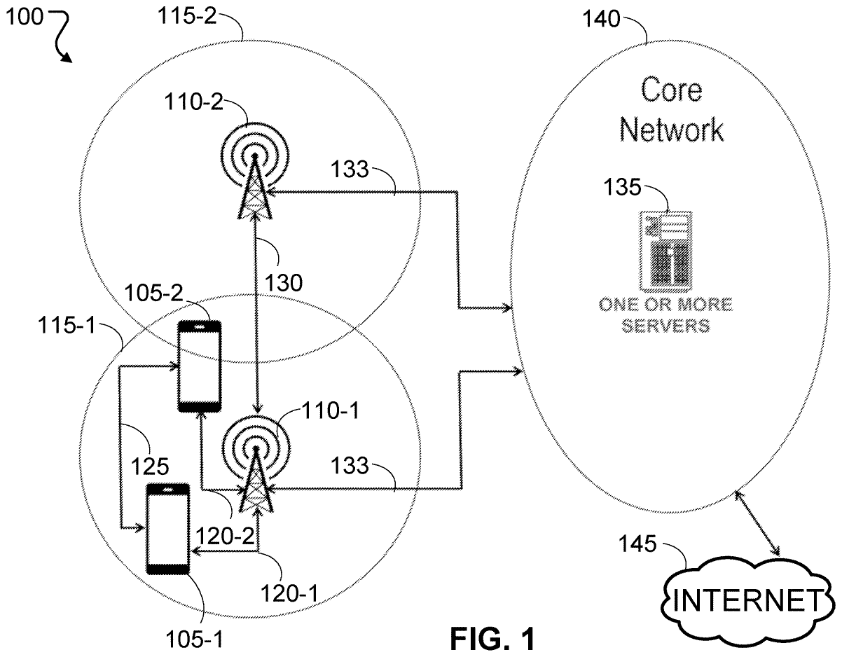

FIG. 1 illustrates an example communication system 100 that includes sidelink communications, according to some implementations. It is noted that the system of FIG. 1 is merely one example of a possible system, and that features of this disclosure may be implemented in other wireless communication systems.

The following description is provided for an example communication system that operates in conjunction with fifth generation (5G) networks as provided by 3GPP technical specifications. However, the example implementations are not limited in this regard and the described examples may apply to other networks that may benefit from the principles described herein, such as 3GPP Long Term Evolution (LTE) networks, Wi-Fi or Worldwide Interoperability for Microwave Access (WiMaX) networks, and the like. Furthermore, other types of communication standards are possible, including future 3GPP systems (e.g., Sixth Generation (6G)), IEEE 802.16 protocols, or the like. While aspects may be described herein using terminology commonly associated with 5G NR, aspects of the present disclosure can be applied to other systems, such as 3G, 4G, and/or systems subsequent to 5G (e.g., 6G).

Frequency bands for 5G NR may be separated into two different frequency ranges. Frequency Range 1 (FR1) may include frequency bands operating in sub-6 GHz frequencies, some of which are bands that may be used by previous standards and may potentially be extended to cover new spectrum offerings from 410 MHz to 7125 megahertz (MHz). Frequency Range 2 (FR 2) may include frequency bands from 24.25 GHz to 52.6 GHz. Bands in the millimeter wave (mmWave) range of FR2 may have smaller coverage but potentially higher available bandwidth than bands in the FR1.

As shown, the communication system 100 includes a number of user devices. More specifically, the communication system 100 includes two UEs 105 (UE 105-1 and UE 105-2 are collectively referred to as “UE 105” or “UEs 105”), two base stations 110 (base station 110-1 and base station 110-2 are collectively referred to as “base station 110” or “base stations 110”), two cells 115 (cell 115-1 and cell 115-2 are collectively referred to as “cell 115” or “cells 115”), and one or more servers 135 in a core network (CN) 140 that is connected to the Internet 145.

In some implementations, the UEs 105 can directly communicate with base stations 110 via links 120 (link 120-1 and link 120-2 are collectively referred to as “link 120” or “links 120”), which utilize a direct interface with the base stations referred to as a “Uu interface.” Each of the links 120 can represent one or more channels. The links 120 are illustrated as an air interface to enable communicative coupling, and can be consistent with cellular communication protocols, such as a GSM protocol, a CDMA network protocol, a UMTS protocol, a 3GPP LTE protocol, an Advanced long term evolution (LTE-A) protocol, an LTE-based access to unlicensed spectrum (LTE-U), a 5G protocol, a NR protocol, an NR-based access to unlicensed spectrum (NR-U) protocol, and/or any of the other communications protocols discussed herein.

As shown, certain user devices may be able to conduct communications with one another directly, e.g., without an intermediary infrastructure device such as base station 110-1. In this example, UE 105-1 may conduct communications directly with UE 105-2. Similarly, the UE 105-2 may conduct communications directly with UE 105-1. Such peer-to-peer communications may utilize a “sidelink” interface such as a PC5 interface. In certain implementations, the PC5 interface supports direct cellular communication between user devices (e.g., between UEs 105), while the Uu interface supports cellular communications with infrastructure devices such as base stations. For example, the UEs 105 may use the PC5 interface for a radio resource control (RRC) signaling exchange between the UEs (also called PC5-RRC signaling). The PC5/Uu interfaces are used only as an example, and PC5 as used herein may represent various other possible wireless communications technologies that allow for direct sidelink communications between user devices, while Uu in turn may represent cellular communications conducted between user devices and infrastructure devices, such as base stations.

In some implementations, the UEs 105 may be configured with parameters for communicating via the Uu interface and/or the sidelink interface. In some examples, the UEs 105 may be “pre-configured” with some parameters. In these examples, the parameters may be hardwired into the UEs 105 or coded into spec. Additionally and/or alternatively, the UEs 105 may receive the parameters from the one or more of the base stations 110.

To transmit/receive data to/from one or more base stations 110 or UEs 105, the UEs 105 may include a transmitter/receiver (or alternatively, a transceiver), memory, one or more processors, and/or other like components that enable the UEs 105 to operate in accordance with one or more wireless communications protocols and/or one or more cellular communications protocols. The UEs 105 may have multiple antenna elements that enable the UEs 105 to maintain multiple links 120 and/or sidelinks 125 to transmit/receive data to/from multiple base stations 110 and/or multiple UEs 105. For example, as shown in FIG. 1, UE 105-1 may connect with base station 110-1 via link 120 and simultaneously connect with UE 105-2 via sidelink 125.

In some implementations, one or more sidelink radio bearers may be established on the sidelink 125. The sidelink radio bearers can include signaling radio bearers (SL-SRB) and/or data radio bearers (SL-DRB).

The PC5 interface may alternatively be referred to as a sidelink interface and may include one or more logical channels, including but not limited to a Physical Sidelink Control Channel (PSCCH), a Physical Sidelink Shared Channel (PSSCH), a Physical Sidelink Discovery Channel (PSDCH), a Physical Sidelink Broadcast Channel (PSBCH), Physical Sidelink Feedback Channel (PSFCH), and/or any other like communications channels. The PSFCH carries feedback related to the successful or failed reception of a sidelink transmission. The PSSCH can be scheduled by sidelink control information (SCI) carried in the sidelink PSCCH. In some examples, the sidelink interface can operate on an unlicensed spectrum (e.g., in the unlicensed 5 Gigahertz (GHz) and 6 GHz bands) or a (licensed) shared spectrum.

In one example, the sidelink interface implements vehicle-to-everything (V2X) communications. The V2X communications may, for example, adhere to 3GPP Cellular V2X (C-V2X) specifications, or to one or more other or subsequent standards whereby vehicles and other devices and network entities may communicate. V2X communications may utilize both long-range (e.g., cellular) communications as well as short- to medium-range (e.g., non-cellular) communications. Cellular-capable V2X communications may be called Cellular V2X (C-V2X) communications. C-V2X systems may use various cellular radio access technologies (RATs), such as 4G LTE or 5G NR RATs (or RATs subsequent to 5G, e.g., 6G RATs). Certain LTE standards usable in V2X systems may be called LTE-Vehicle (LTE-V) standards. As used herein in the context of V2X systems, and as defined above, the term “user devices” may refer generally to devices that are associated with mobile actors or traffic participants in the V2X system, e.g., mobile (able-to-move) communication devices such as vehicles, pedestrian user equipment (PUE) devices, and roadside units (RSUs).

In some implementations, UEs 105 may be physical hardware devices capable of running one or more applications, capable of accessing network services via one or more radio links 120 with a corresponding base station 110 (also referred to as a “serving” base station), and capable of communicating with one another via sidelink 125. Link 120 may allow the UEs 105 to transmit and receive data from the base station 110 that provides the link 120. The sidelink 125 may allow the UEs 105 to transmit and receive data from one another. The sidelink 125 between the UEs 105 may include one or more channels for transmitting information from UE 105-1 to UE 105-2 and vice versa and/or between UEs 105 and UE-type RSUs and vice versa.

In some implementations, the base stations 110 are capable of communicating with one another over a backhaul connection 130 and may communicate with the one or more servers 135 within the CN 140 over another backhaul connection 133. The backhaul connections can be wired and/or wireless connections.

In some implementations, the UEs 105 are configured to use a resource pool for sidelink communications. A sidelink resource pool defines the time-frequency resources used for sidelink communications, and may be divided into multiple time slots, frequency channels, and frequency sub-channels. In some examples, the UEs 105 are synchronized and perform sidelink transmissions aligned with slot boundaries. A UE may be expected to select several slots and sub-channels for transmission of the transport block. In some examples, a UE may use different sub-channels for transmission of the transport block across multiple slots within its own resource selection window.

In some implementations, an exceptional resource pool may be configured for the UEs 105, perhaps by the base stations 110. The exceptional resource pool includes resources that the UEs 105 can use in exceptional cases, such as Radio Link Failure (RLF). The exceptional resource pool may include resources selected based on a random allocation of resources.

In some implementations, a UE that is initiating a communication with another UE is referred to as a transmitter UE (TX UE), and the UE receiving the communication is referred to as a receiver UE (RX UE). For example, UE 105-1 may be a TX UE and UE 105-2 may be an RX UE. Although FIG. 1 illustrates a single TX UE communicating with a single RX UE, a TX UE may communicate with more than one RX UE via sidelink.

In some implementations, a TX UE that is initiating sidelink communication may determine the available resources (e.g., sidelink resources) and may select a subset of these resources to communicate with an RX UE based on a resource allocation scheme. Example resource allocation schemes include Mode 1 and Mode 2 resource allocation schemes. In Mode 1 resource allocation scheme (referred to as “Mode 1”), the resources are allocated by a network node for in-coverage UEs. In Mode 2 resource allocation scheme (referred to as “Mode 2”), the TX UE selects the sidelink resources (e.g., sidelink transmission resources).

In some implementations, the communication system 100 supports different cast types, including unicast, broadcast, and groupcast (or multicast) communications. Unicast refers to direction communications between two UEs. Broadcast refers to a communication that is broadcast by a single UE to a plurality of other UEs. Groupcast refers to communications that are sent from a single UE to a set of UEs that satisfy a certain condition (e.g., being a member of a particular group).

Channel state information (CSI) acquisition is generally used only for unicast scenarios. The channel state information reference signal (CSI-RS) configuration is given by PC5 radio resource control (PC5-RRC) configuration data from the UE transmitting the CSI-RS. The CSI can be enabled or disabled by configuration. CSI measurement on sidelink CSI-RS can be based on CSI-RS confined in the physical sidelink shared channel (PSSCH). There is no standalone CSI-RS transmission dedicated to CSI reporting. There is no standalone interference measurement for CSI. The SCI, associated with PSSCH containing CSI-RS, triggers the CSI reporting. The CSI reference resources include the time domain, specifying the slot where CSI trigger is received. The CSI reference resources include the frequency domain, wherein the physical resource blocks (PRBs) are scheduled for the PSSCH in the CSI reference resource slot. The NR CSI-RS sequence is the baseline for SL CSI-RS sequence at least with the following modification: n_ID is determined by the 10-bit least significant bit (LSB) of the cyclic redundancy check (CRC) of the corresponding 1st SCI.

CSI reporting can be aperiodic reporting and can contain a channel quality indicator (CQI) and rank indication (RI), either 1 or 2. Generally, there is no pre-coding matrix indicator (PMI). CSI is carried on PSSCH. Higher layer signaling (i.e., MAC CE) is generally used for CQI/RI reporting. A sidelink CQI/RI measurement is based on existing physical layer procedure for Uu. A reporting window can be as follows. A transmitting (Tx) user equipment (UE) cannot send multiple CSI triggers with overlapping CSI report window in a given unicast session. The CSI report has a latency bound that results from signaling from CSI triggering UE to CSI reporting UE via PC5-RRC. A CQI table is derived based on an indicated modulation and coding scheme.

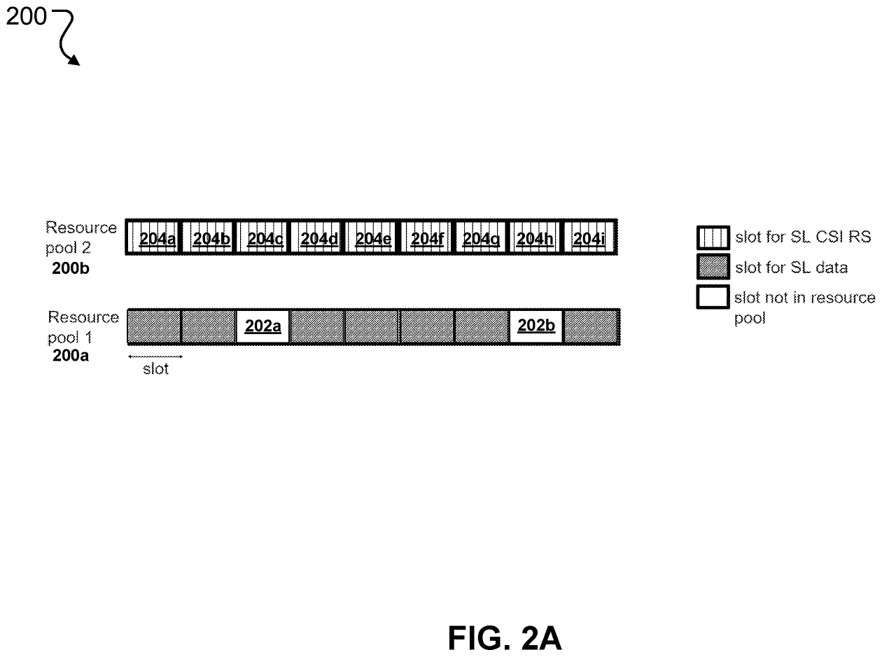

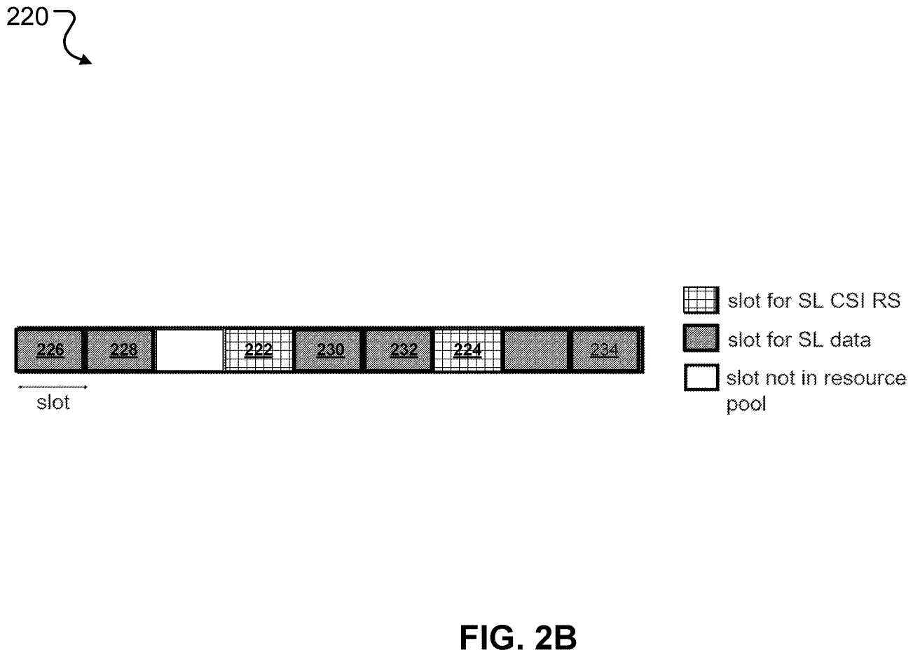

FIG. 2A illustrates an example of a physical layer structure for dedicated SL CSI-RS transmission. The physical layer structure includes the frame structures 200 that include resource pools 1 and 2. Resource pool 2 includes frame structure 200b. Resource pool 1 includes frame structure 200a.

The Tx UE provides dedicated slot(s) for SL CSI-RS transmissions in frame structure 200b of resource pool 2. Each of the SL slot(s) 204a-204i for standalone CSI-RS can include multiple AGC symbols, in contrast to legacy SL slots that each include only one AGC symbol. The slots of resource pool 2 are not suitable for data transmission, as for data transmission there is only one AGC symbol.

The UE can have a dedicated resource pool 2 for slots 204a-i for SL CSI-RS transmission. The resource pool 1 includes a frame 200a can be a legacy resource pool for SL data transmission. Each unit of resource pool 1 and resource pool 2 is one slot. Slots 202a and 202b are not allocated in the resource pool 1 for legacy SL data transmission.

Resource pool 2 includes slots 204a-i in a frame 200b that are dedicated for SL CSI-RS transmissions. Each of the slots 204a-i of resource pool 2 can include multiple AGC symbols. There is no sidelink data transmission in resource pool 2. In a first example, sidelink control information (SCI) stage 1 and SCI stage 2 are transmitted in resource pool 2. The SCI stage 2 information can include a full source identifier (e.g., 24 bits) and/or full destination identifier (e.g., 24 bits). The source identifier identifies a source or transmitting UE and the destination identifier identifies a destination or receiving UE. As such, a receiving UE can decode the SCI and determine that the transmission is intended for that particular Rx UE. In another example, the SCI stage 2 information can include a partial source identifier (e.g., 8 bits) and/or partial destination identifier (e.g., 16 bits). The partial source identifier can be used to identify a source or transmitting UE and the partial destination identifier can be used to identify a destination or receiving UE. Because beam management is for sidelink unicast, the resource pool 2 is also used for SL unicast transmissions. Generally, the resource pool 2 is only used for SL unicast transmissions.

The resource pool 2, in another example, can include only a SCI stage 1 transmission. In this example, the source identifier and destination identifier are each included in the SCI stage 1 transmission.

Generally, the resource pool 2 does not include physical sidelink feedback channel (PSFCH) resources. The resource pool 2 can include only the resources reserved for CSI-RS and the SCI state 1 and/or stage 2.

FIG. 2B illustrates an example of a frame structure 220 for dedicated SL CSI-RS transmission. The frame structure 200 includes a physical layer structure for standalone sidelink CSI-RS transmissions in a common resource pool with additional slots for SL data transmission. The frame structure 220 is configured to include dedicated slots 222, 224 for standalone SL CSI-RS transmissions, rather than a separate resource pool (e.g., resource pool 2 of FIG. 2A). The slots 222, 224 for standalone CSI-RS transmission are allocated within a common resource pool including slots allocated for SL data, such as slots 226, 228, 230, 232, and 234. These slots 226, 228, 230, 232, and 234 can be remaining slots that are not allocated for CSI-RS transmission that are also part of the resource pool.

Some dedicated slots 222, 224 in the resource pool 220 are allocated for SL CSI-RS transmission. A location and a periodicity of the dedicated slots 222, 224 are (pre)configured by the resource pool. In an example, an additional bitmap is used to indicate the dedicated SL CSI-RS slots. The dedicated slots are a subset of the slots allocated for the resource pool. A bitmap (e.g., sl-TimeResource-r16) can define the location and periodicity of the dedicated slots 222, 224. A different bitmap, having a same length on the time resource as the legacy bitmap indicating the SL data resources, can be used to indicate the dedicated slots for standalone SL CSI-RS transmissions. If the legacy bitmap that defines the resource pool 220 is defined as sl-TimeResource-r16=[1,1,0,1,1,1,1,0,1], then the new bitmap that defines the dedicated slots for CSI-RS transmission sl-CSIRSTimeResource=[0,0,0,1,0,0,1,0,0]. The bitmap sl-CSIRSTimeResource indicates that the 4th slot 222 and the 7th slot 224 in a resource pool 220 slot bitmap are dedicated for SL CSI-RS transmissions. Though 9 bits are shown to represent the nine bits in the resource pool of frame structure 220, 10 bits can be used to represent 10 slots in the resource pool, and so forth.

In another example, a modified version of the legacy bitmap sl-TimeResource-r 16 can be generated for resource allocation. This modified bitmap can indicate the legacy sidelink data transmission slots and also the dedicated CSI-RS transmission slots. For example, a bitmap sl-TimeResource-r16=[1,1,0,2,1,1,1,2,0,1], where “1” indicates the legacy sidelink data transmission slots and “2” indicates the dedicated SL CSI-RS transmission slots. This bitmap therefore represents both the data slots and the standalone SL CSI-RS slot locations in the resource pool.

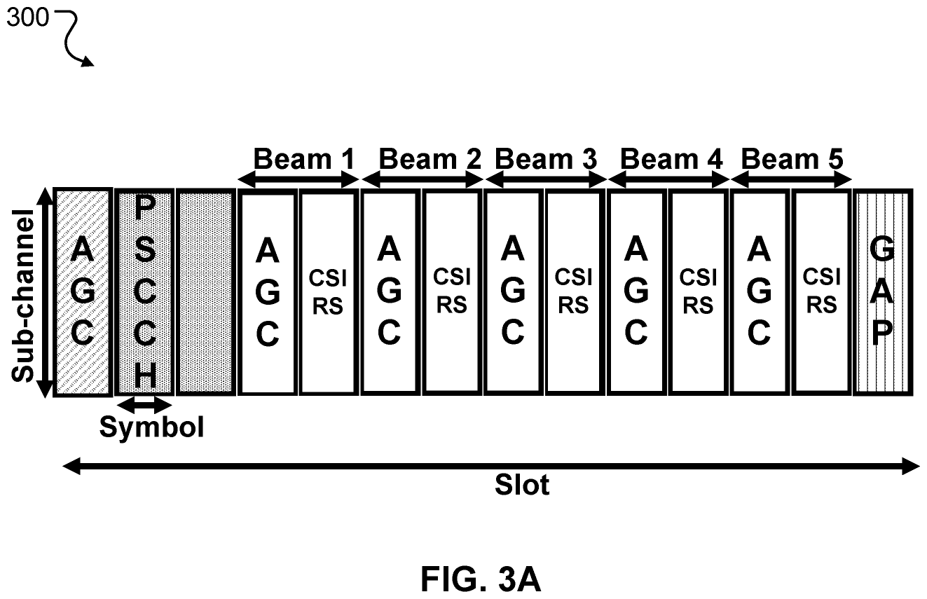

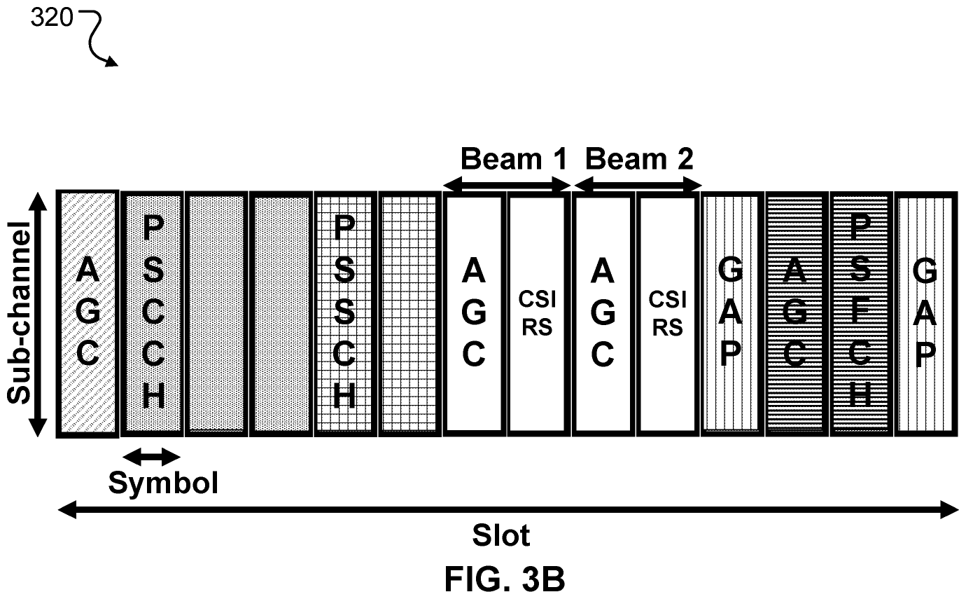

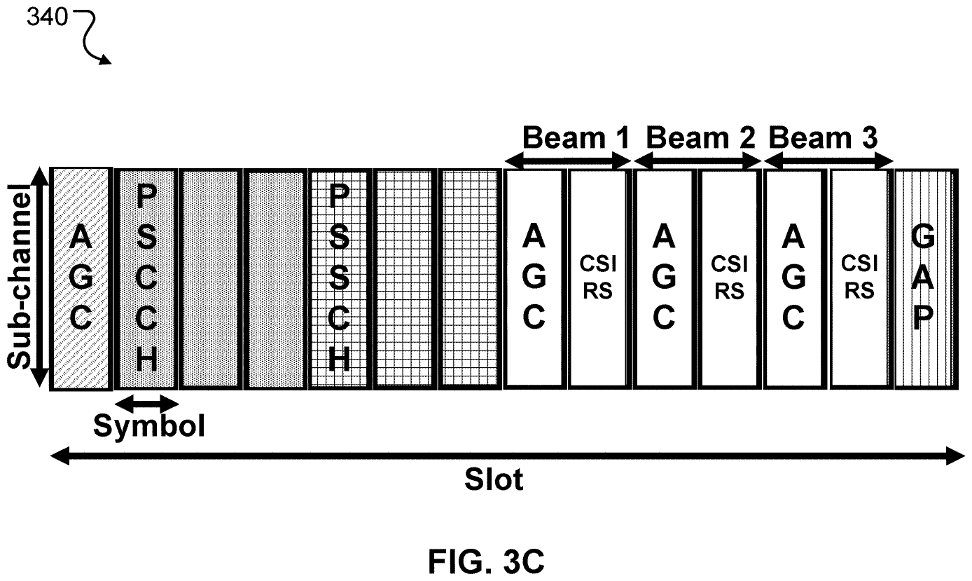

FIG. 3A illustrates an example physical layer slot structure 300 for a standalone SL CSI-RS transmission. Slot 300 is an example slot configuration in which five beams are included. The slot 300 includes an initial AGC symbol, followed by two symbols for physical sidelink control channel (PSCCH) information. Each of the five beams follows the PSCCH symbols. Each beam has an AGC symbol followed by a symbol allocated for CSI-RS transmission. There are six AGC symbols total within the slot 300 for a five beam configuration shown in FIG. 3A. The AGC symbols are at symbols #0, #3, #5, #7, #9, and #11. The final symbol is a gap symbol.

The slot 300 can be included in the frame 200a (e.g., as one of slots 204a-i or slots 222, 224) of resource pool 2 of FIG. 2A or the resource pool of frame 220 of FIG. 2B. The slot 300 is dedicated for SL CSI-RS transmissions. In each dedicated slot (e.g., slot 300), a number and location(s) of AGC symbols are determined as follows. In a first example, the number and locations of AGC symbols can be (pre)configured per resource pool. For example, in slot 300, AGC symbols are at positions #0, #3, #5, #7, #9, and #11, as there are five indicated beams. In another example, the AGC symbols are statically pre-defined (e.g., symbol #7, #9 and #11). The number and locations can depend on whether or not there is PSFCH in the same slot (e.g., in slot 300). In a slot with PSFCH, as shown by slot 320 of FIG. 3B, a number and locations of AGC symbols can be differently (pre)configured/pre-defined from slot 300, which does not include PSFCH symbols. Each SL CSI-RS transmission session length is determined by the locations of AGC symbols in the slot 300.

FIG. 3B illustrates an example slot 320 of a physical layer structure for a standalone SL CSI-RS transmission. Slot 320 is similar to slot 300 of FIG. 3A except that the symbols of the slot are configured for including different information in comparison to slot 300. Slot 320 is an example slot configuration in which two beams are included. The slot 320 includes an initial AGC symbol, followed by three symbols for physical sidelink control channel (PSCCH) information. Two symbols are allocated for physical sidelink shared channel (PSSCH) information. The PSSCH symbols are used for data transmission, and generally include the SCI stage 2 information. Each of the two beams follows the PSSCH symbols. Each beam has an AGC symbol followed by a symbol allocated for CSI-RS transmission. A gap symbol is then included, followed by the feedback channel PSFCH. The final symbol is a gap symbol. There are therefore four AGC symbols within the slot 320. The slot 320 can be included in the frame 200a (e.g., as one of slots 204a-i or slots 222, 224) of resource pool 2 of FIG. 2A or the resource pool of frame 220 of FIG. 2B. The slot 320 is dedicated for SL CSI-RS transmissions.

In each dedicated slot (e.g., slot 320), a number and location(s) of AGC symbols are determined in a manner similar as described in relation to FIG. 3A. In this example, for slot 320, PSSCH symbols are included. For such a slot 320 with PSFCH, the locations of AGC symbols could be pre-defined as symbol #7 and #9 only (e.g., in addition to required AGC symbols at #0 and #11) or allocated as such dynamically. Each SL CSI-RS transmission session length is determined by the locations of AGC symbols in the slot 320.

FIG. 3C illustrates an example slot 340 of a physical layer structure for a standalone SL CSI-RS transmission. Slot 340 is similar to slot 300 of FIG. 3A and/or slot 320 of FIG. 2B, except that the symbols of the slot 340 are configured for including different information in comparison to slots 300 and 320. Slot 340 is an example slot configuration in which three beams are included. The slot 340 includes an initial AGC symbol, followed by three symbols for physical sidelink control channel (PSCCH) information. Three symbols are allocated for physical sidelink shared channel (PSSCH) information. The PSSCH symbols are used for data transmission, and generally include the SCI stage 2 information, including source and destination identifiers for the sidelink transmissions. Each of the three beams follows the three PSSCH symbols. Each beam has an AGC symbol followed by a symbol allocated for CSI-RS transmission. The final symbol is a gap symbol. There are therefore four AGC symbols within the slot 340 at symbols #0, #7, #9, and #11, of which symbols #7, #9, and #11 can be configurable or predefined. The slot 340 can be included in the frame 200a (e.g., as one of slots 204a-i or slots 222, 224) of resource pool 2 of FIG. 2A or the resource pool of frame 220 of FIG. 2B. The slot 320 is dedicated for SL CSI-RS transmissions.

In each dedicated slot (e.g., slot 340), a number and location(s) of AGC symbols are determined in a manner similar as described in relation to FIG. 3A or 3B. In this example, for slot 320, PSSCH symbols are not included. Each SL CSI-RS transmission session length is determined by the locations of AGC symbols in the slot 340. The slot 340 includes symbols for multiple transmissions of CSI-RSs for corresponding beams for beam sweeping. For each beam, the receiver UE can use the AGC symbol for AGC. For each slot 300, 320, and 340, each of the CSI-RS symbols can be a copy for transmission on different beams. In other words, the contents of each CSI-RS symbol can be the same as the subsequent or previous CSI-RS symbols. Additionally, slots 300, 320, and 340 are three examples provided for illustrative purposes, but the slot can be reconfigured with many other configurations not shown in FIGS. 3A-3C. Slots 300, 320, and 340 are merely examples of possible slot configurations, though there are many various permutations and/or combinations of symbols that are possible for the slot configuration in accordance with the parameters described herein. For example, the PSSCH can occupy two symbols as shown in slot 320, three symbols as shown in slot 340, or other numbers of symbols for other slots (not shown).

In the above examples, it is possible that each SL CSI-RS transmission is accompanied with a PSCCH transmission and/or PSSCH transmission. In this case, there are multiple PSCCH and/or PSSCH transmissions in a slot.

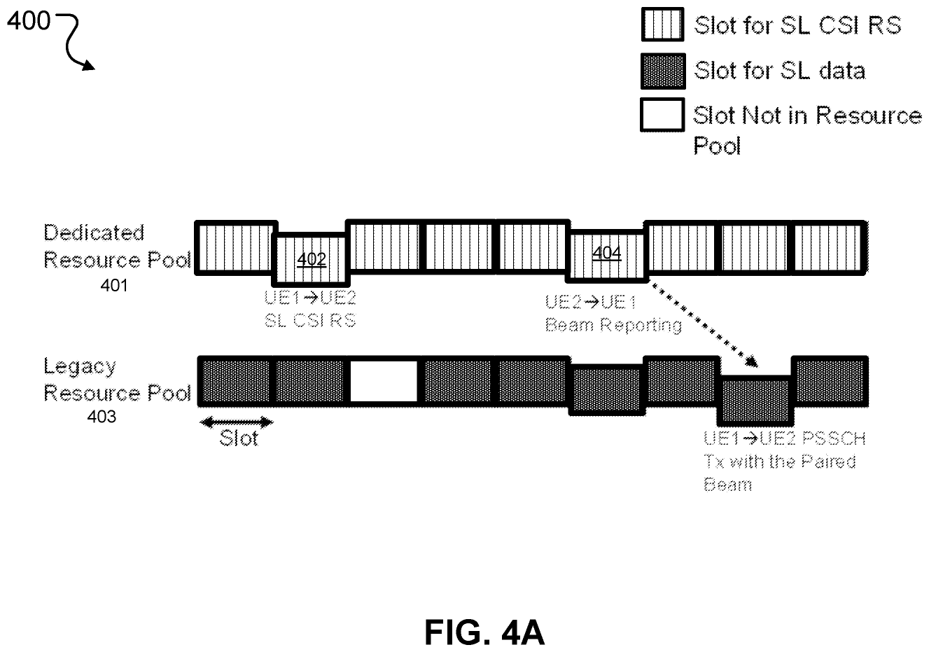

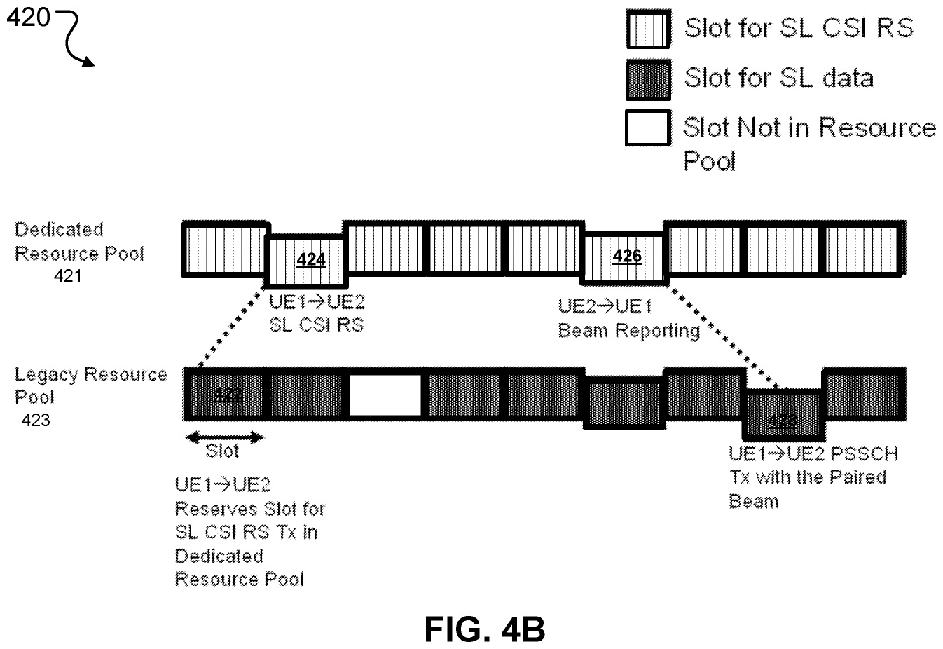

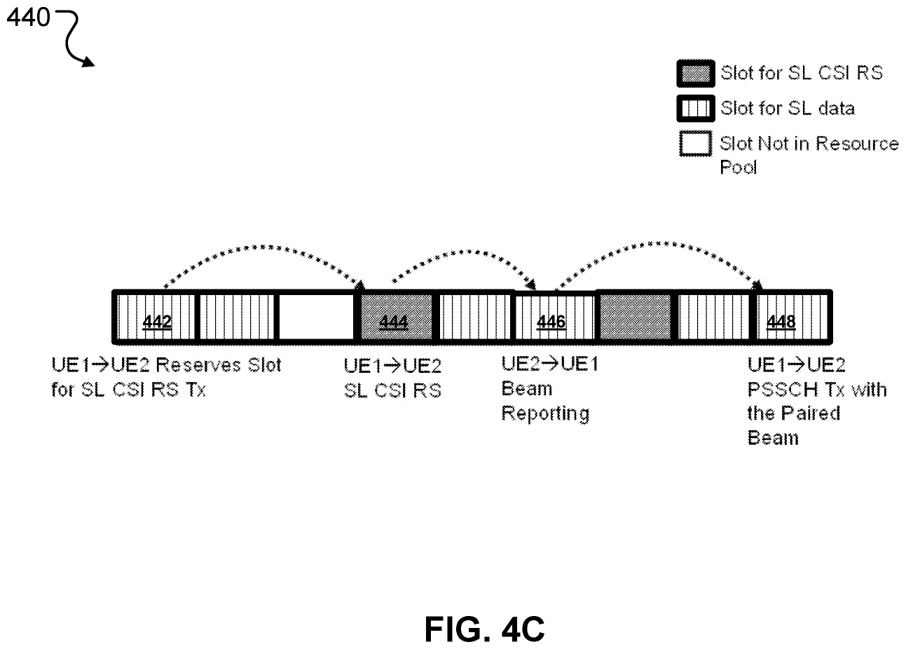

FIG. 4A illustrates an example of resource allocation 400 for a standalone SL CSI-RS transmission. The resource allocation specifies, to the transmitting UE, which sub-channel is to be used in the resource pool for the SL CSI-RS transmission. A dedicated resource pool 401 and a legacy resource pool 403 are included as available resources. Each of the dedicated resource pool 401 and the legacy resource pool 403 include a respective set of slots.

In the scenario of FIG. 4A, there is a dedicated resource pool 401 for sidelink CSI-RS transmission. In this scenario, in a first example, there are independent transmissions on a dedicated resource pool 401 for sidelink CSI-RS transmissions and on the legacy resource pool 403 for data transmission, as described in relation to FIG. 2A an shown in resources 400. There are therefore independent operations for the dedicated resource pool 401 and the legacy resource pool 403.

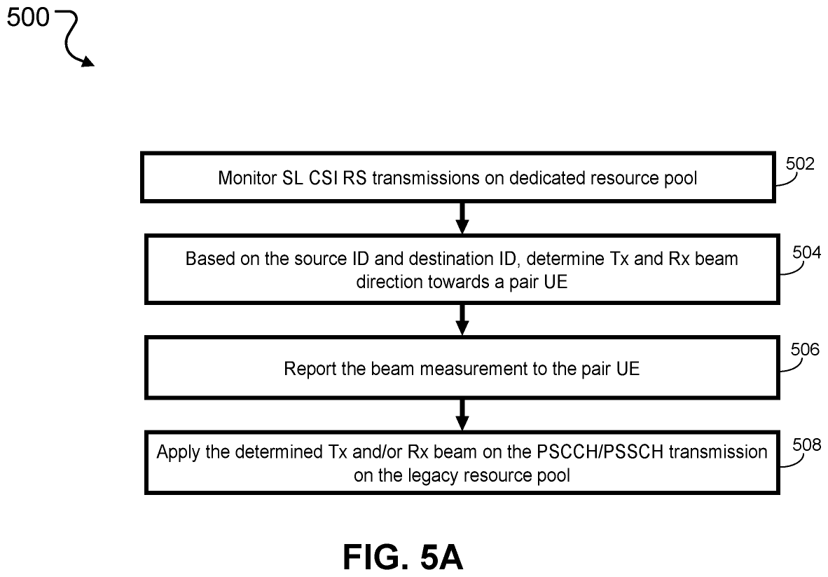

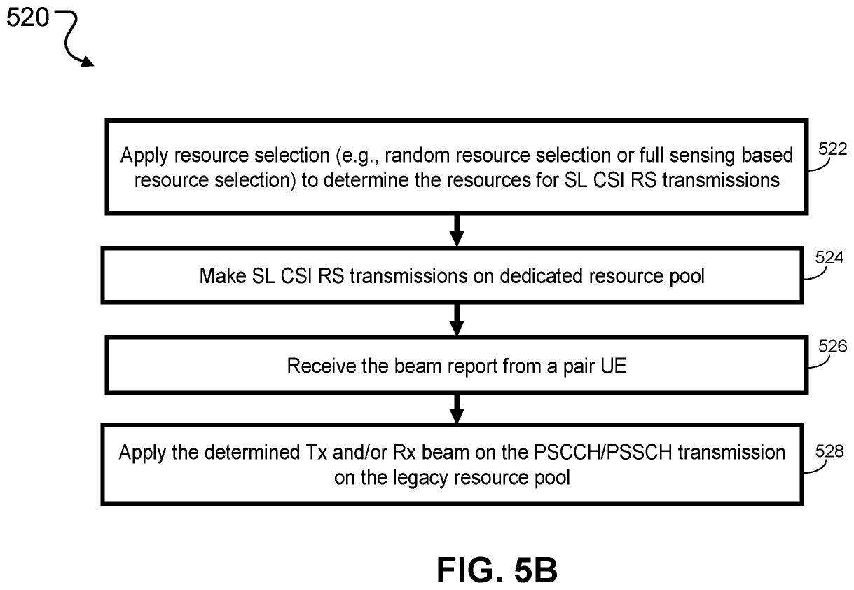

A process 500 performed by the Rx UE is now described, as shown in FIG. 5A in relation to the resource pools 400 of FIG. 4A. The receiver UE is configured to monitor (502) the dedicated resource pool 401 for SL CSI-RS transmissions, such as that which occurs at slot 402. Based on the monitoring of the dedicated resource pool 401 for SL CSI-RS transmissions, the Rx UE determines (504) the transmitter/receiver beam towards a paired transmitting UE (e.g., Tx UE). Specifically, the Rx UE determines a source identifier and a destination identifier using the monitoring. The Rx UE determines the Rx beam and the Tx beam direction towards the paired UE (e.g., the Tx UE).

The beam reporting can occur at slot 404. The receiver UE reports (506) the beam measurement to the paired UE (e.g., the Tx UE). The Tx UE sends the PSSCH transmission with the reported paired beam. In some implementations, the transmission is sent using the legacy resource pool 403. In another example, the beam report transmission is sent by the Rx UE using the dedicated resource pool 401. In some implementations, the beam reporting by the Rx UE may indicate which dedicated resource pool is used for beam measurement.

The Rx UE applies (508) the determined Tx/Rx beam in a PSCCH/PSSCH transmission on the legacy resource pool for data transmissions. For example, the PSCCH/PSSCH transmission can occur at slot 406. The Rx UE adjusts the beam pair accordingly based on the identified pair UE. In this approach, the resource selection on the dedicated resource pool 401 is independent of the resource selection on the legacy resource pool 403.

A process 520 performed by the Tx UE is now described, as shown in FIG. 5B in relation to the resource pools 400 of FIG. 4A. The Tx UE can be paired with the Rx UE of process 500. The Tx UE is configured to apply (522) resource selection for SL CSI-RS transmissions on the dedicated resource pool 401. In some implementations, the Tx UE applies a random resource selection in which the transmitting UE randomly selects a sub-channel in the dedicated resource pool 401 for transmitting the CSI-RS. In some implementations, the Tx UE applies a full sensing-based resource selection. In this example, the Tx UE monitors SCI transmitted on dedicated resource pool 401 and measures reference signal receive power (RSRP) of the signal in order to select the sub-channel for the CSI-RS transmission. The Tx UE can perform a legacy resource selection procedure based on the monitored SCI.

The Tx UE is configured to perform (524) SL CSI-RS transmissions on the dedicated resource pool 401, such as at slot 402. The Tx UE is configured to receive (526) the beam report from the paired UE (e.g., the Rx UE of FIG. 5A). The Tx UE can receive the report at slot 404 of the dedicated resource pool 401. The Tx UE is configured to apply (528) the determined transmission or receiving beam on the PSCCH/PSSCH transmission using the legacy resource pool 403. For example, the PSCCH/PSSCH transmission can occur at slot 406. In this approach, the resource selection on the dedicated resource pool 401 is independent of the resource selection on the legacy resource pool 403.

FIG. 4B illustrates an example of resource allocation of resource pools 420 for a standalone SL CSI-RS transmission. The resource allocation specifies, to the transmitting UE, which sub-channel is to be used in the resource pool for the SL CSI-RS transmission. A dedicated resource pool 421 and a legacy resource pool 423 are included as available resources. Each of the dedicated resource pool 421 and the legacy resource pool 423 include a respective set of slots.

In the scenario of FIG. 4B, there is the dedicated resource pool 421 for sidelink CSI-RS transmission. There are dependent transmissions on the dedicated resource pool 421 for sidelink CSI-RS transmissions and a legacy resource pool 423 for data transmission. SCI are transmitted on legacy resource pool for data transmission reserves the resources for sidelink CSI-RS transmission. The transmission resources for the CSI-RS on the dedicated resource pool 421 are reserved using the legacy resource pool 423. The Tx UE monitors the SCI on the legacy resource pool 423. At slot 422, for example, the Tx UE reserves a slot in the dedicated resource pool 421 for SL CSI-RS transmission. This slot can be slot 424. The Tx UE determines which resources are reserved and which resources are available on the dedicated resource pool 421. Based on the monitoring the legacy resource pool 421, the Tx UE reserves the slot 424 of the dedicated resource pool 421 using the SCI for transmission of the CSI-RS. The SCI can indicate the source identifier and the destination identifier, as subsequently described. Beam measurement and reporting can be performed using either the dedicated resource pool 421 or the legacy resource pool 423. In FIG. 4B, measurement and reporting are shown at slot 426 of the dedicated resource pool 421. The beam reporting indicates the particular beam to transmit data to the Rx UE, from the Tx UE, in the legacy resource pool 423 (e.g., for PSCCH/PSSCH). The Tx UE can transmit the data using the indicated beam. The resource selection for the dedicated resource pool 421 depends on the resource reservation in the legacy resource pool 423, linking transmissions for the resource pools 420.

The SCI for data transmission is transmitted using the legacy resource pool 423 for reserving the resources for CSI-RS transmission. The container for the SL CSI-RS transmission resources reservation can be either the SCI stage 1 or SCI stage 2 (in a new format) or MAC CE. The SL SCI reservation of the SCI container can include the following data. The SCI container can specify a time slot of SL CSI-RS resources (e.g., slot 424). The time slot can be indicated in DFN, or a slot offset between the SCI and SL CSI-RS. The SCI container can indicate the frequency domain of the SCI slot. The frequency of SL CSI-RS resources cane expressed in terms of sub-channel index in the dedicated resource pool. The particular sub-channel for SL SCI-RS transmissions can be specified. The SCI container can specify a periodicity of SL CSI-RS resources. The periodicity is based on supported periodicity values that are (pre)configured in the dedicated resource pool 421 or in the legacy resource pool 423. The SCI container can specify the index of the dedicated resource pool 421 for SL CSI-RS transmission, such as which particular dedicated resource pool is selected. The receiving UE can receive the PSSCH transmission with the paired beam, such as slot 428 of the legacy resource pool 423.

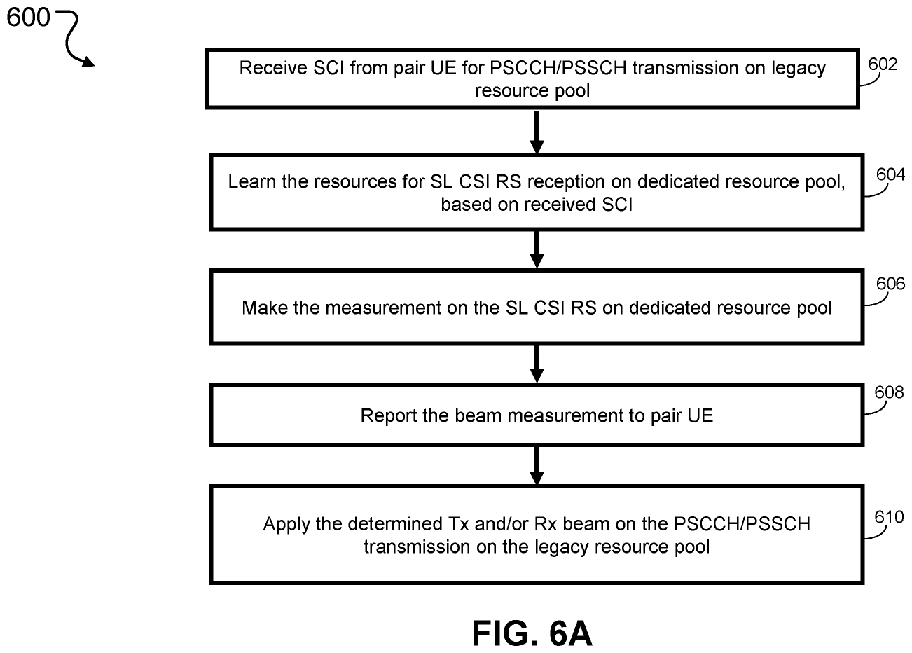

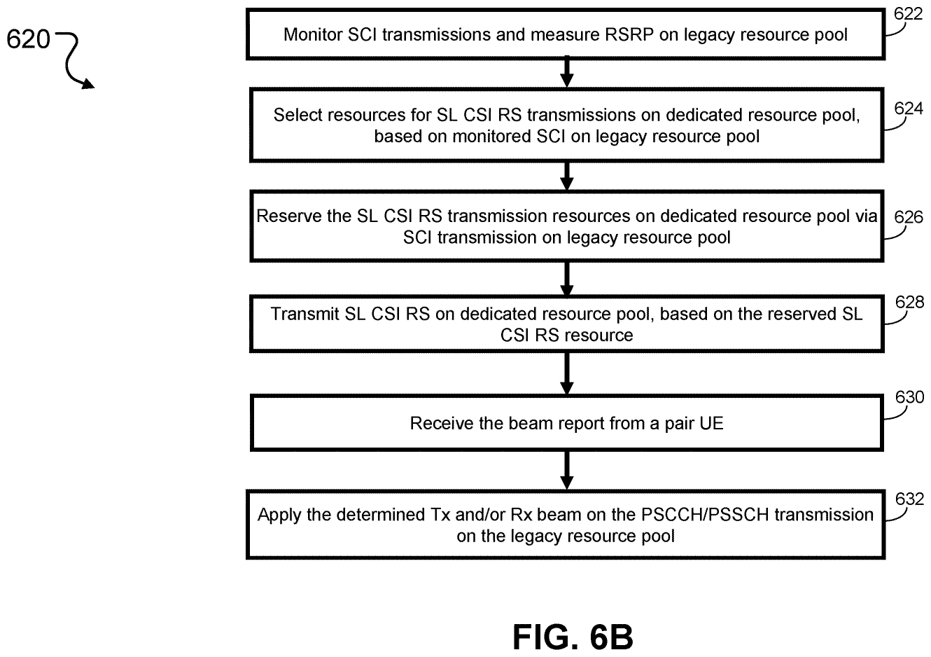

FIGS. 6A-6B illustrate example processes 600, 620 for resource allocation for a standalone SL CSI-RS transmission in accordance with the resource allocation of FIG. 4B. The resource allocation specifies, to the transmitting UE, which sub-channel is to be used in the resource pool for the SL CSI-RS transmission. A dedicated resource pool and a legacy resource pool are included as available resources. The dedicated resource pool is for sidelink CSI-RS transmission. There are dependent transmissions on the dedicated resource pool for sidelink CSI-RS transmissions and a legacy resource pool for data transmission. SCI are transmitted on legacy resource pool for data transmission reserves the resources for sidelink CSI-RS transmission. The transmission resources for the CSI-RS on the dedicated resource pool are reserved using the legacy resource pool.

Process 600 of FIG. 6A is performed by a receiving UE (Rx UE) for determining the Tx/Rx beam based on the dedicated resource pool. The UE is configured to receive (602) SCI from the paired UE (e.g., the Tx UE) for PSCCH/PSSCH data transmissions on the legacy resource pool. The Rx UE is configured to determine (604) the resources for the SL SCI-RS reception (e.g., slot 424 of FIG. 4B) based on the SCI. The resources are on the dedicated resource pool. The Rx UE is configured to perform (606) the measurement on the SL CSI-RS dedicated resource pool. The Rx UE is configured to report (608) the beam measurement to the pair UE (e.g., the Tx UE). The Rx UE is configured to apply (610) the determined Tx and/or Rx beam on the PSCCH/PSSCH transmission using the legacy resource pool.

Process 620 of FIG. 6B is performed by a transmitting UE (Tx UE) for determining the Tx/Rx beam based on the dedicated resource pool in accordance with the resource pools of FIG. 4B, previously described. The Tx UE can be paired with the Rx UE of process 600. The UE is configured to monitor (622) SCI transmissions and measure the RSRP on the legacy resource pool. The Tx UE is configured to select (624) resources for SL CSI-RS transmissions on the dedicated resource pool. The selection is based on the monitored SCI on the legacy resource pool. The Tx UE is configured to reserve (626) the SL CSI-RS transmission resources on the dedicated resource pool by way of the SCI transmission on the legacy resource pool. The Tx UE is configured to transmit (628) the SL CSI-RS on the dedicated resource pool in accordance with the reserved SL SCI-RS resource (e.g., slot, sub-channel, etc.). The Tx UE is configured to receive (630) a beam report from the paired UE (e.g., the Rx UE). The Tx UE is configured to apply (632) the determined transmission and/or receiving beam on the PSCCH/PSSCH transmission on the legacy resource pool.

FIG. 4C illustrates an example of resource allocation for a standalone SL CSI-RS transmission using a single, shared resource pool 440. Some slots of the resource pool 440 are for data transmission, and other slots are reserved for CSI-RS transmissions. More specifically, there are dedicated slots for sidelink CSI-RS transmissions and other slots for PSCCH/PSSCH transmissions. The UE 1 monitors the SCI or MAC CE transmissions and decodes the SCI or MAC CE transmissions to determine which resources are reserved for CSI-RS transmissions. The UE 1 can indicate (e.g., at slot 442) to the UE 2 to perform a measurement on a particular slot and/or sub-channel. The indication by the UE 1 is sent to the UE 2 along with some data. The UE 2 can measure at the specified slot (e.g., slot 444). The UE 2 can report to the UE 1 regarding the measurement result (e.g., at slot 446). The UE 1 can apply the new beams as reported from the UE 2 to transmit using the new beam (e.g., at slot 448). Here, the Tx UE selects the CSI-RS transmission resources to avoid collisions in the shared resource pool because the Tx UE has information specifying which slots and/or sub-channels have been reserved by other UEs. The Tx UE selects available resources for reservation for being dedicated for CSI-RS transmission.

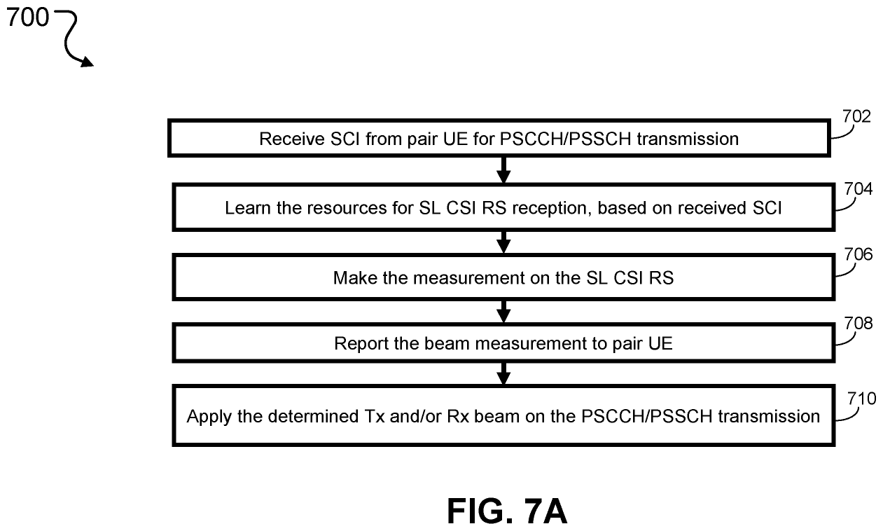

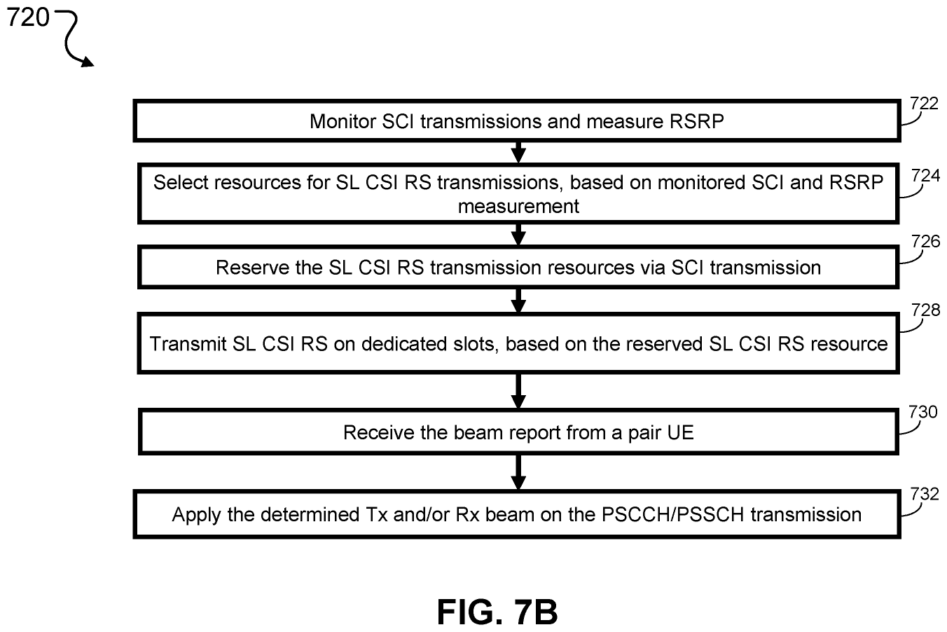

FIGS. 7A-7B illustrate example processes 700, 720 for resource allocation for a standalone SL CSI-RS transmission in accordance with a resource allocation of FIG. 4C. The resource allocation specifies, to the transmitting UE, which sub-channel is to be used in the resource pool for the SL CSI-RS transmission. A shared resource pool is included as available resources. The shared resource pool is for sidelink CSI-RS transmissions and data transmission. SCI are transmitted for data transmission reserves the resources for sidelink CSI-RS transmission. The transmission resources for the CSI-RS on the dedicated resource pool are reserved using the legacy resource pool.

Process 700 of FIG. 7A is performed by a receiving UE (Rx UE) for determining the Tx/Rx beam based on the dedicated resource pool. The Rx UE is configured to receive (702) SCI from the paired UE (e.g., a Tx UE) for PSCCH/PSSCH transmission. The Rx UE is configured to determine (704) the resources for SL CSI-RS reception. The determination is based on the received SCI. The Rx UE is configured to perform (706) the measurement on the SL CSI-RS using the specified resource of the shared resource pool. The Rx UE is configured to report (708) the beam measurement to the paired UE (e.g., the Tx UE). The Rx UE is configured to apply (710) the determined Tx and/or Rx beam on the PSCCH/PSSCH transmission.

Process 720 of FIG. 7B is performed by a receiving UE (Rx UE) for determining the Tx/Rx beam based on the dedicated resource pool. The Tx UE can be paired with the Rx UE of process 700. The Tx UE is configured to monitor (722) SCI transmissions and measure the RSRP on the shared resource pool. The Tx UE is configured to select (724) resources for SL CSI-RS transmissions on the shared resource pool. The selection is based on the monitored SCI and the RSRP measurement. The Tx UE is configured to reserve (726) the SL CSI-RS transmission resources in the shared resource pool by the SCI transmission on the shared resource pool. The Tx UE is configured to transmit (728) the SL CSI-RS on the dedicated slots of the shared resource pool in accordance with the reserved SL SCI-RS resource (e.g., slot, sub-channel, etc.). The Tx UE is configured to receive (630) a beam report from the paired UE (e.g., the Rx UE). The Tx UE is configured to apply (632) the determined transmission and/or receiving beam on the PSCCH/PSSCH transmission on the shared resource pool.

In another scenario, a resource pool based sidelink CSI-RS configuration can be performed. In Uu links, the initial link paring is based on the synchronization signal block (SSB). In SL, the SSB link may be unsuitable for beam pairing, because the SSB does not include the UE source or UE destination identifiers. For beam pairing, the pair UE is to be identified. Because the SL SSB is unsuitable, the SL CSI-RS can be used for initial beam pairing. The sidelink CSI-RS beams could be wide beam, similar the SL SSB. The CSI-RS can be done using standalone CSI-RS transmission, where the time and frequency resources of sidelink CSI-RS previously described in relation to FIGS. 1-7B are used. The SCI is associated with the sidelink CSI-RS transmissions, where SCI includes the source identifier and/or the destination identifier. The CSI-RS is therefore a wider beam for beam pairing but is performed using the standalone CSI-RS configuration.

The example methods 500, 520, 600, 620, 700, and 720 shown in FIGS. 5A-7B can be modified or reconfigured to include additional, fewer, or different steps (not shown in FIGS. 5A-7B), which can be performed in the order shown or in a different order.

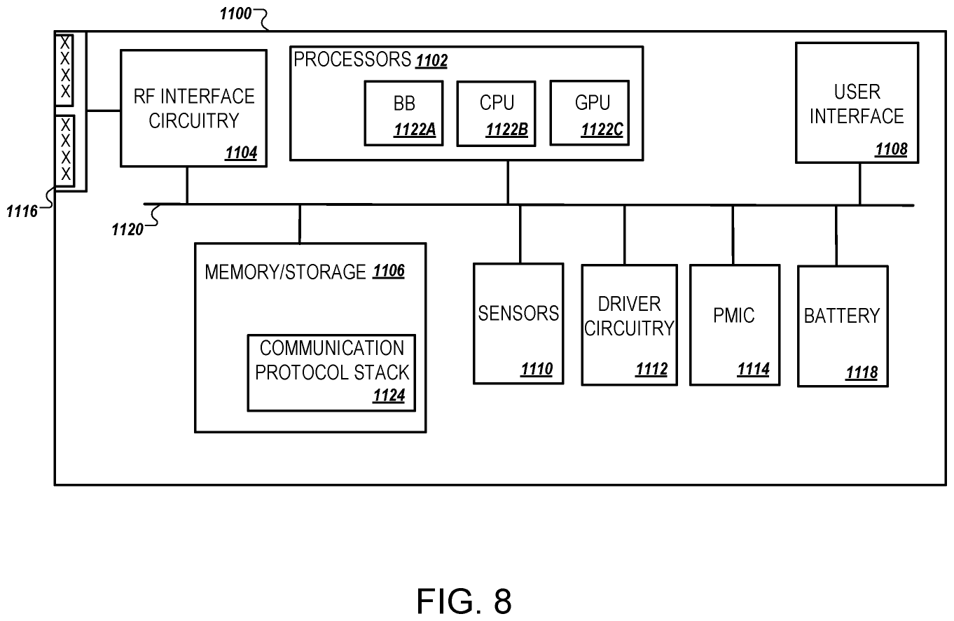

FIG. 8 illustrates an example UE 1100, according to some implementations. The UE 1100 may be similar to and substantially interchangeable with UEs 105 of FIG. 1.

The UE 1100 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 1100 may include processors 1102, RF interface circuitry 1104, memory/storage 1106, user interface 1108, sensors 1110, driver circuitry 1112, power management integrated circuit (PMIC) 1114, one or more antenna(s) 1116, and battery 1118. The components of the UE 1100 may be implemented as integrated circuits (ICs), portions thereof, discrete electronic devices, or other modules, logic, hardware, software, firmware, or a combination thereof. The block diagram of FIG. 8 is intended to show a high-level view of some of the components of the UE 1100. However, some of the components shown may be omitted, additional components may be present, and different arrangement of the components shown may occur in other implementations.

The components of the UE 1100 may be coupled with various other components over one or more interconnects 1120, which may represent any type of interface, input/output, bus (local, system, or expansion), transmission line, trace, optical connection, etc. that allows various circuit components (on common or different chips or chipsets) to interact with one another.

The processors 1102 may include processor circuitry such as, for example, baseband processor circuitry (BB) 1122A, central processor unit circuitry (CPU) 1122B, and graphics processor unit circuitry (GPU) 1122C. The processors 1102 may include any type of circuitry or processor circuitry that executes or otherwise operates computer-executable instructions, such as program code, software modules, or functional processes from memory/storage 1106 to cause the UE 1100 to perform operations as described herein.

In some implementations, the baseband processor circuitry 1122A may access a communication protocol stack 1124 in the memory/storage 1106 to communicate over a 3GPP compatible network. In general, the baseband processor circuitry 1122A may access the communication protocol stack to perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 1104. The baseband processor circuitry 1122A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 1106 may include one or more non-transitory, computer-readable media that includes instructions (for example, communication protocol stack 1124) that may be executed by one or more of the processors 1102 to cause the UE 1100 to perform various operations described herein. The memory/storage 1106 include any type of volatile or non-volatile memory that may be distributed throughout the UE 1100. In some implementations, some of the memory/storage 1106 may be located on the processors 1102 themselves (for example, L1 and L2 cache), while other memory/storage 1106 is external to the processors 1102 but accessible thereto via a memory interface. The memory/storage 1106 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1104 may include transceiver circuitry and radio frequency front module (RFEM) that allows the UE 1100 to communicate with other devices over a radio access network. The RF interface circuitry 1104 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna(s) 1116 and proceed to filter and amplify (with a low-noise amplifier) the signal. The signal may be provided to a receiver of the transceiver that downconverts the RF signal into a baseband signal that is provided to the baseband processor of the processors 1102.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna(s) 1116. In various implementations, the RF interface circuitry 1104 may be configured to transmit/receive signals in a manner compatible with NR access technologies.

The antenna(s) 1116 may include one or more antenna elements to convert electrical signals into radio waves to travel through the air and to convert received radio waves into electrical signals. The antenna elements may be arranged into one or more antenna panels. The antenna(s) 1116 may have antenna panels that are omnidirectional, directional, or a combination thereof to enable beamforming and multiple input, multiple output communications. The antenna(s) 1116 may include microstrip antennas, printed antennas fabricated on the surface of one or more printed circuit boards, patch antennas, phased array antennas, etc. The antenna(s) 1116 may have one or more panels designed for specific frequency bands including bands in FR1 or FR2.

The user interface 1108 includes various input/output (I/O) devices designed to enable user interaction with the UE 1100. The user interface 1108 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 1100.

The sensors 1110 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1112 may include software and hardware elements that operate to control particular devices that are embedded in the UE 1100, attached to the UE 1100, or otherwise communicatively coupled with the UE 1100. The driver circuitry 1112 may include individual drivers allowing other components to interact with or control various input/output (I/O) devices that may be present within, or connected to, the UE 1100. For example, driver circuitry 1112 may include a display driver to control and allow access to a display device, a touchscreen driver to control and allow access to a touchscreen interface, sensor drivers to obtain sensor readings of sensors 1110 and control and allow access to sensors 1110, drivers to obtain actuator positions of electro-mechanic components or control and allow access to the electro-mechanic components, a camera driver to control and allow access to an embedded image capture device, audio drivers to control and allow access to one or more audio devices.

The PMIC 1114 may manage power provided to various components of the UE 1100. In particular, with respect to the processors 1102, the PMIC 1114 may control power-source selection, voltage scaling, battery charging, or DC-to-DC conversion.

In some implementations, the PMIC 1114 may control, or otherwise be part of, various power saving mechanisms of the UE 1100. A battery 1118 may power the UE 1100, although in some examples the UE 1100 may be mounted deployed in a fixed location and may have a power supply coupled to an electrical grid. The battery 1118 may be a lithium ion battery, a metal-air battery, such as a zinc-air battery, an aluminum-air battery, a lithium-air battery, and the like. In some implementations, such as in vehicle-based applications, the battery 1118 may be a typical lead-acid automotive battery.

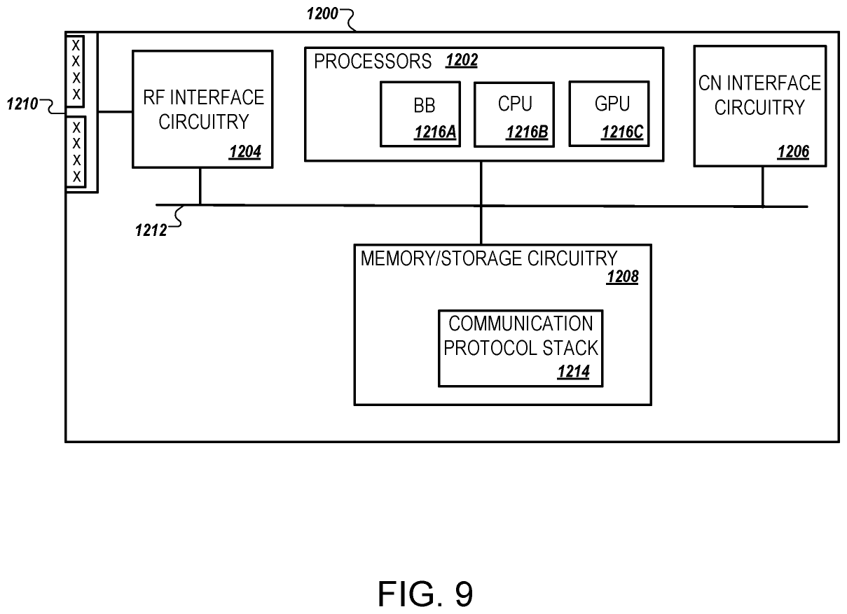

FIG. 9 illustrates an example access node 1200 (e.g., a base station or next generation node gNB), according to some implementations. The access node 1200 may be similar to and substantially interchangeable with base stations 110. The access node 1200 may include processors 1202, RF interface circuitry 1204, core network (CN) interface circuitry 1206, memory/storage circuitry 1208, and one or more antenna(s) 1210.

The components of the access node 1200 may be coupled with various other components over one or more interconnects 1212. The processors 1202, RF interface circuitry 1204, memory/storage circuitry 1208 (including communication protocol stack 1214), antenna(s) 1210, and interconnects 1212 may be similar to like-named elements shown and described with respect to FIG. 8. For example, the processors 1202 may include processor circuitry such as, for example, baseband processor circuitry (BB) 1216A, central processor unit circuitry (CPU) 1216B, and graphics processor unit circuitry (GPU) 1216C.

The CN interface circuitry 1206 may provide connectivity to a core network, for example, a 5th Generation Core network (5GC) using a 5GC-compatible network interface protocol such as carrier Ethernet protocols, or some other suitable protocol. Network connectivity may be provided to/from the access node 1200 via a fiber optic or wireless backhaul. The CN interface circuitry 1206 may include one or more dedicated processors or FPGAs to communicate using one or more of the aforementioned protocols. In some implementations, the CN interface circuitry 1206 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 1200 that operates in an NR or 5G system (for example, a gNB), and the term “E-UTRAN node” or the like may refer to an access node 1200 that operates in an LTE or 4G system (e.g., an eNB). According to various implementations, the access node 1200 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 1200 may be implemented as one or more software entities running on server computers as part of a virtual network, which may be referred to as a CRAN and/or a virtual baseband unit pool (vBBUP). In V2X scenarios, the access node 1200 may be or act as a “Roadside Unit.” The term “Roadside Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Examples

Example 1 is a method including receiving, by a user equipment (UE), a sidelink channel state reference signal (CSI-RS) transmission on a first resource pool dedicated for CSI-RS transmissions; transmitting, by the UE and based on the CSI-RS transmission, a beam report to a paired UE, the beam report being based on a transmission beam and a receiver beam associated with a source identifier and a destination identifier in sidelink control information (SCI); and receiving, based on the transmission beam and the receiver beam of the beam report, a transmission on a second resource pool for data transmissions.

Example 2 includes the method of example 1, further including receiving, from the paired UE, a SCI transmission specifying a resource of the first resource pool that is selected by the paired UE for transmission of the CSI-RS, wherein the CSI-RS is received by the UE using the selected resource of the first resource pool.

Example 3 includes the method of any of examples 1 or 2, wherein the SCI is transmitted using a slot of the second resource pool.

Example 4 includes the method of any of examples 1 or 2, wherein the SCI specifies the resource of the first resource pool for transmission of the CSI-RS using a container in SCI stage 1.

Example 5 includes the method of any of examples 1 or 2, wherein the SCI specifies the resource of the first resource pool for transmission of the CSI-RS using a container in SCI stage 2.

Example 6 includes the method of any of examples 1 or 2, wherein the SCI specifies a time slot of the first resource pool for the CSI-RS transmission.

Example 7 includes the method of any of examples 1 or 2, wherein the SCI specifies a sub-channel index the first resource pool for the CSI-RS transmission.

Example 8 includes the method of any of examples 1 or 2, wherein the SCI specifies a periodicity for the CSI-RS transmission using the first resource pool.

Example 9 includes the method of any of examples 1 or 2, wherein the SCI specifies an index of the first resource pool.

Example 10 includes the method of any of examples 1 to 9, wherein the first resource pool is reserved for CSI-RS transmissions only.

Example 11 includes the method of any of examples 1 to 10, wherein the first resource pool is reserved for CSI-RS transmissions and SCI stage 2 transmissions.

Example 12 includes the method of example 11, wherein the SCI stage 2 transmissions include a full source identifier identifying the paired UE and/or a full destination identifier identifying the UE.

Example 13 includes the method of example 11, wherein the SCI stage 2 transmissions include a partial source identifier the paired UE and/or a partial destination identifier identifying the UE.

Example 14 includes the method of any of examples 1 to 13, wherein the first resource pool is reserved for CSI-RS transmissions and SCI stage 1 transmissions.

Example 15 includes the method of any of examples 1 to 14, wherein the first resource pool includes one or more slots that are dedicated for CSI-RS transmissions, the one or more slots being configured or preconfigured by the first resource pool.

Example 16 includes the method of example 15, wherein a bitmap indicates the one or more slots, the bitmap including values specifying each slot that is dedicated for SL CSI-RS transmissions and each slot that is used for data transmissions.

Example 17 includes the method of example 15, wherein a bitmap indicates the one or more slots, the bitmap including values specifying each slot that is dedicated for SL CSI-RS transmissions.

Example 18 includes the method of any of examples 1 to 17, wherein each slot in the first resource pool that is dedicated for CSI-RS transmissions includes a symbol for automatic gain control (AGC) for each CSI-RS transmission associated with the slot.

Example 19 includes the method of example 18, wherein a slot in the first resource pool that is dedicated for CSI-RS transmissions includes an additional AGC symbols for each beam configured for transmission of a respective CSI-RS in the slot.

Example 20 includes the method of example 18, wherein the slot is configured for transmission of the CSI-RS on at least two beams.

Example 21 includes the method of any of examples 1 to 20, wherein the first resource pool and the second resource pool are part of a shared resource pool on a single frame structure.

Example 22 includes the method of any of examples 1 to 21, further including performing beam pairing using a CSI-RS configured or preconfigured by resource pool.

Example 23 includes the method of any of examples 1 to 22, wherein the CSI-RS is transmitted using a wide beam.

Example 24 includes the method of any of examples 1 to 23, wherein the transmission on the second resource pool includes a physical sidelink control channel (PSCCH) or physical sidelink shared channel (PSSCH).

Example 25 includes a non-transitory computer storage medium encoded with instructions that, when executed by one or more computers, cause the one or more computers to perform the method of any of examples 1 to 24.

Example 26 includes a system comprising one or more processors and one or more storage devices on which are stored instructions that are operable, when executed by the one or more processors, to cause the one or more processors to perform the method of any of examples 1 to 24.

Example 27 includes an apparatus comprising one or more baseband processors configured to perform the method of any of examples 1 to 24.

Example 28 includes an apparatus comprising one or more baseband processors configured to perform the method of any of examples 1 to 24.

Any of the above-described examples may be combined with any other example (or combination of examples), unless explicitly stated otherwise. The foregoing description of one or more implementations provides illustration and description but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1-28. (canceled)

29. One or more processors configured to, when executing instructions stored in a memory, perform operations comprising:
decoding a sidelink channel state reference signal (CSI-RS) transmission on a first resource pool dedicated for CSI-RS transmissions;
encoding for transmitting, based on the CSI-RS transmission, a beam report to a paired UE, the beam report being based on a transmission beam and a receiver beam associated with a source identifier and a destination identifier in sidelink control information (SCI); and
decoding, based on the transmission beam and the receiver beam of the beam report, a transmission on a second resource pool for data transmissions.

30. The one or more processors of claim 29, the operations further comprising:
decoding, from the paired UE, a SCI transmission specifying a resource of the first resource pool that is selected by the paired UE for transmission of the CSI-RS, wherein the CSI-RS is received using the selected resource of the first resource pool.

31. The one or more processors of claim 30, wherein the SCI is transmitted using a slot of the second resource pool,
wherein the SCI specifies the resource of the first resource pool for transmission of the CSI-RS using a container in SCI stage 1,
wherein the SCI specifies the resource of the first resource pool for transmission of the CSI-RS using a container in SCI stage 2,
wherein the SCI specifies a time slot of the first resource pool for the CSI-RS transmission,
wherein the SCI specifies a sub-channel index the first resource pool for the CSI-RS transmission,
wherein the SCI specifies a periodicity for the CSI-RS transmission using the first resource pool, or
wherein the SCI specifies an index of the first resource pool.

32. The one or more processors of claim 29, wherein the first resource pool is reserved for CSI-RS transmissions only.

33. The one or more processors of claim 29, wherein the first resource pool is reserved for CSI-RS transmissions and SCI stage 2 transmissions.

34. The one or more processors of claim 33, wherein the SCI stage 2 transmissions include a full source identifier identifying the paired UE and/or a full destination identifier identifying the UE.

35. The one or more processors of claim 33, wherein the SCI stage 2 transmissions include a partial source identifier the paired UE and/or a partial destination identifier identifying the UE.

36. The one or more processors of claim 29, wherein the first resource pool is reserved for CSI-RS transmissions and SCI stage 1 transmissions.

37. The one or more processors of claim 29, wherein the first resource pool includes one or more slots that are dedicated for CSI-RS transmissions, the one or more slots being configured or preconfigured by the first resource pool.

38. The one or more processors of claim 37, wherein a bitmap indicates the one or more slots, the bitmap including values specifying each slot that is dedicated for SL CSI-RS transmissions and each slot that is used for data transmissions.

39. The one or more processors of claim 37, wherein a bitmap indicates the one or more slots, the bitmap including values specifying each slot that is dedicated for SL CSI-RS transmissions.

40. The one or more processors of claim 29, wherein each slot in the first resource pool that is dedicated for CSI-RS transmissions includes a symbol for automatic gain control (AGC) for each CSI-RS transmission associated with the slot.

41. The one or more processors of claim 40, wherein a slot in the first resource pool that is dedicated for CSI-RS transmissions includes an additional AGC symbols for each beam configured for transmission of a respective CSI-RS in the slot.

42. The one or more processors of claim 40, wherein the slot is configured for transmission of the CSI-RS on at least two beams.

43. The one or more processors of claim 29, wherein the first resource pool and the second resource pool are part of a shared resource pool on a single frame structure.

44. The one or more processors of claim 29, further comprising performing beam pairing using a CSI-RS configured or preconfigured by resource pool.

45. The one or more processors of claim 44, wherein the CSI-RS is transmitted using a wide beam.

46. The one or more processors of claim 29, wherein the transmission on the second resource pool includes a physical sidelink control channel (PSCCH) or physical sidelink shared channel (PSSCH).

47. An apparatus comprising one or more processors and one or more storage devices on which are stored instructions that are operable, when executed by the one or more processors, to cause the one or more processors to perform operations comprising:
decoding a sidelink channel state reference signal (CSI-RS) transmission on a first resource pool dedicated for CSI-RS transmissions;
encoding for transmitting, based on the CSI-RS transmission, a beam report to a paired UE, the beam report being based on a transmission beam and a receiver beam associated with a source identifier and a destination identifier in sidelink control information (SCI); and
decoding, based on the transmission beam and the receiver beam of the beam report, a transmission on a second resource pool for data transmissions.

48. A method comprising:
decoding a sidelink channel state reference signal (CSI-RS) transmission on a first resource pool dedicated for CSI-RS transmissions;
encoding for transmitting, based on the CSI-RS transmission, a beam report to a paired UE, the beam report being based on a transmission beam and a receiver beam associated with a source identifier and a destination identifier in sidelink control information (SCI); and
decoding, based on the transmission beam and the receiver beam of the beam report, a transmission on a second resource pool for data transmissions.
